(19) United States
(12) Patent Application Publication
(10) Pub. No.: US 2014/0286244 A1
(43) Pub. Date: Sep. 25, 2014

(54) METHOD AND APPARATUS FOR CONTROLLING NEAR FIELD WIRELESS NETWORK

(71) Applicant: ELECTRONICS AND TELECOMMUNICATIONS RESEARCH INSTITUTE, Daejeon (KR)

(72) Inventors: Gwangzeen KO, Daejeon (KR); Jinhyung OH, Daejeon (KR); Igor KIM, Daejeon (KR); Myung Sun SONG, Daejeon (KR)

(21) Appl. No.: 13/944,411

(22) Filed: Jul. 17, 2013

(30) Foreign Application Priority Data
Mar. 19, 2013 (KR) 10-2013-0029209

(51) Int. Cl. H04L 5/00

(52) U.S. Cl. CPC H04L 5/0092
USPC 370/329

(57) ABSTRACT

An apparatus for controlling a near field wireless network, includes a wireless network controller included in a management plane of a wireless access point and configured to observe wireless physical layer/media access controller layer (PHY/MAC) protocols and perform a management procedure on wired MAC/PHY protocols within the wireless access point. Further, the apparatus includes a wireless network central management unit included in a management plane of a switch and configured to perform a management procedure on the wired MAC/PHY protocols within the switch.

### CROSS-REFERENCE TO RELATED APPLICATION(S)

The present invention claims priority of Korean Patent Application No. 10-2013-0029209, filed on Mar. 19, 2013, which is incorporated herein by reference.

### FIELD OF THE INVENTION

The present invention relates to a near field wireless network control technology, and more particularly, to a method and apparatus for controlling a near field wireless network, which are appropriate for providing a particular function to a near field wireless network at a switch (or a router) used when wireless access devices attempt to establish a connection to a wired network.

### BACKGROUND OF THE INVENTION

FIG. 1 shows the configuration of a general near field wireless network in the related art.

As shown in FIG. 1, in the near field wireless network, wireless terminals 109, 110, and 111 access wireless access points (AP) through a wireless line 114 to transmit data, respectively.

Upon receiving the data from the wireless terminals 109, 110, and 111, the wireless access points 105, 106, and 107 transmit the received data to a switch 102 and a router 101, respectively. At this point, a wired line such as a wired access point 104 may be connected to the switch 102.

The router 101 has a structure that supports a connection to a wide area network such as the Internet via a network 103.

The conventional switch 102 serves to determine paths of data frames transferred from the network 103 based on media access control (MAC) addresses of the respective wireless access points 105, 106, and 107, and the wired access point 104 connected to the switch 102 and distribute them to devices connected to the switch 102, or determine whether MAC frames received from the wireless access points 105, 106, and 107 and the wired access point 104 are directed to a device connected to the switch 102 or an external device not connected to the switch 102 to establish a path.

Recently, the switches tend to have additional functions regarding handover between wireless access points, authentication, security, and the like, but such functions are fundamentally promoted within the original range of the switches such as “path establishment and management” for a MAC frame.

FIG. 2 shows protocol stacks of the respective devices of the network structure described above with reference to FIG. 1.

That is, FIG. 2 shows detailed protocols of the protocols that perform the process of transmitting data from the wireless terminal 111 to the switch 102 through the wireless access point 107, as shown in FIG. 1.

A wireless terminal 201 transmits data of higher layers than 3-layer of an open system interconnection (OSI) layer model to a wireless access point 202 (which corresponds to reference numeral 107 in FIG. 1) through a wireless line 204 (which corresponds to reference numeral 114 in FIG. 1) via a 3-layer protocol 2011, a 2-layer higher protocol 2012, a wireless protocol MAC 2013, and a wireless physical layer (PHY) protocol 2014, and the wireless access point 202 converts wireless protocols 2021 and 2022 into wired protocols 2024 and 2025 and transmits the same to a switch 203 through a wired line 205 (which corresponds to reference numeral 115 in FIG. 1).

The switch 203 adds a higher layer protocol 2034 thereto and transmits the same to the wide area network 103 through the router 101 of FIG. 1. At this time, a 2-layer higher protocol 2033 of the switch 203 performs a 2-layer path management as mentioned above with reference to FIG. 1.

However, recently, as the number of wireless access points has been rapidly increased and the transmission areas such as the coverage of the wireless access points 112 and 113 have increasingly overlapped, the necessity of effectively controlling a near field wireless network has emerged. Conventionally, in order to control the near field wireless network, the techniques of establishing a direct MAC layer line between the wireless access points 105 and 106 or between the wireless access points 106 and 107, or among the wireless access points 105, 106, and 107, to exchange required control information therebetween have been proposed.

In this control scheme based on a direct link between the wireless access points, the respective wireless access points are the subjects for determining a delay time of information exchange and a particular situation, having a limitation in effectively controlling in the overall network.

### SUMMARY OF THE INVENTION

In view of the above, therefore, the present invention provides a method for managing a wireless network using a wired line within a switch, rather than a conventionally discussed method of direct communication through a wireless line between wireless access points.

Thus, the complexity of wireless protocol management due to direct communication between the wireless access points can be removed, and a wireless network can be simply, rapidly, and intelligently managed without an additional revision of a 2-layer protocol through a switch to which the wireless access points are connected.

Further, the present invention provides a method for managing a transmission time of each wireless network.

In accordance with a first aspect of the present invention, there is an apparatus for controlling a near field wireless network, including: a wireless network controller included in a management plane of a wireless access point and configured to observe wireless physical layer/media access controller layer (PHY/MAC) protocols and perform a management procedure on wired MAC/PHY protocols within the wireless access point, and a wireless network central management unit included in a management plane of a switch and configured to perform a management procedure on the wired MAC/PHY protocols within the switch.

Further, the wireless network controller and the wireless network central management unit may be implemented in a plane separately from a data plane and a control plane.

Further, the switch may comprise at least one switch equipment.

Further, the wireless network controller may comprise a communication unit configured to generate a wireless MAC/PHY management frame or a wired MAC/PHY management frame for communication with a second communication device; an information collecting unit configured to collect header information from a frame header of the wireless MAC/PHY management frame; and a controller configured to execute hardware or software of the wireless accession point in response to a command signal received from the wireless network central management unit.

Further, the controller may be configured to transmit the command signal to a wireless terminal through the communication unit.

Further, the command signal may be transmitted to the wireless terminal through the use of a control frame.

Further, the wireless network central management unit may comprise a communication unit configured to perform a communication with a second communication device so that it is connected to a second switch connected to a second router in a network by using a 3-layer protocol included in a data plane of the switch through a wireless network; and an information processing unit configured to analyze network information received from at least one wireless access point connected to the switch to recognize and determine a situation of a network environment.

Further, the communication unit may be configured to communicate with the wireless access point through the use of a MAC/PHY frame of the wired protocol.

Further, the information processing unit may be configured to determine a random variable and transmit a management command to a wireless access point required to be managed through the communication unit.

In accordance with a second aspect of the present invention, there is provided a method for controlling a near field wireless network by a wireless network controller, including: reading a header of a wireless protocol media access control (MAC) and a header of a wireless protocol physical layer (PHY) of a data plane of a wireless access point to collect an operation status of a corresponding wireless access network; generating a wired protocol MAC frame by using the information collected through the header of the wireless protocol MAC and the header of the wireless protocol PHY; and transmitting a wired protocol PHY frame and a wired protocol MAC frame to a switch including a wireless network central management unit as a destination of the information.

Further, the wireless network central management unit may be configured to process the information collected through the headers of the wireless protocol MAC and the wireless protocol PHY and transmit a management command to the wireless access point.

Further, the header of the wireless protocol MAC may comprise network allocation vector (NAV) information.

Further, the NAV information may comprise information used to recognize a target device to which a wireless MAC frame is transmitted.

Further, the NAV information may comprise information regarding a wireless resource occupancy time.

Further, the header of the wireless protocol PHY may comprise information regarding a modulation coding scheme (MCS) of a corresponding frame and signal strength.

In accordance with a third aspect of the present invention, there is provided a method for controlling a near field wireless network by a wireless network central management unit, including: generating a wired protocol media access controller (MAC) frame and a wired protocol physical layer (PHY) frame by using a 2-layer higher protocol for a wireless access point in a wireless network environment; transmitting the generated wired protocol MAC frame and wired protocol PHY frame to a data plane of the wireless access point; and transmitting a wireless network control command to a wireless network controller of the wireless access point.

Further, the wireless network controller may be configured to control a MAC/PHY process of a wireless protocol in response to the wireless network control command to control the near field wireless network.

In accordance with the present invention, the conventional switch role of 2-layer path control can be extended. The conventional wireless network control is performed through direct communication between wireless access points, having a limitation in reliability of information transmission and delay time. In addition, since each wireless access point performs a separate determination, when multiple wireless access points affect each other, the subjects for determining a situation are distributed, and thus, an effective determination cannot be performed over the entire network.

The wireless network control scheme in a switch proposed in the present invention is a scheme of centrally managing multiple wireless access points at a protocol level higher than that of the conventional scheme, thus determining an optimized situation over the entire network, and since the switch corresponds to the respective wireless access points in a one-to-one manner, the wireless network can be effectively managed within a short delay time. In addition, since wireless network information of a corresponding area is shared with a different switch through a network, a wireless network can be more extensively managed.

### BRIEF DESCRIPTION OF THE DRAWINGS

The above and other objects and features of the present invention will become apparent from the following description of embodiments, given in conjunction with the accompanying drawings, in which:

FIG. 1 is a view showing the configuration of a typical near field wireless network in the related art;

FIG. 2 is a view showing protocol stacks of respective devices in the structure of the near field wireless network of FIG. 1;

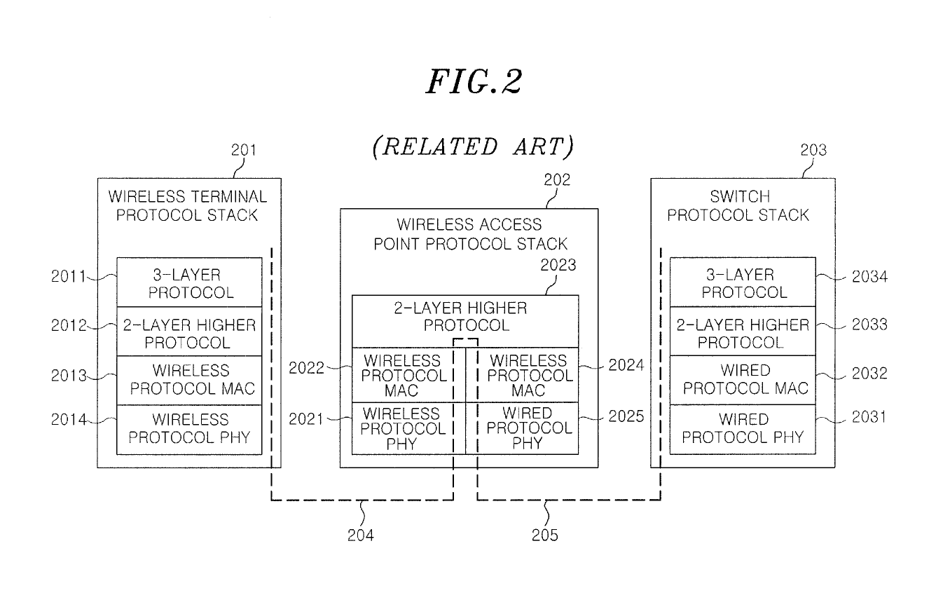

FIG. 3 is a view illustrating the configuration of a connection between a wireless network controller and a wireless network central management unit applied to the near field wireless network in accordance with an embodiment of the present invention;

FIG. 4 is a view illustrating a detailed configuration of the wireless network controller and the wireless network central management unit of FIG. 3;

FIG. 5 is a view illustrating a process of collecting information in the near field wireless network in accordance with an embodiment of the present invention; and

FIG. 6 is a view illustrating a procedure for processing a command by the wireless network central management unit in the near field wireless network in accordance with an embodiment of the present invention.

### DETAILED DESCRIPTION OF THE EMBODIMENT

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Before describing embodiments of the present invention, a switch applied to the present invention is implementable as a single device in terms of its function, like a router, and therefore, the switch may include both a separate switch and a switch integrally implemented within a router. Further, the switch applied to the present invention refer to a bridge, a switch, a router, or the like, which is a previous name thereof, and since the present invention is implemented in these three or more types of equipment, the name of switch will be typically used in the following description of the embodiments.

Hereinafter, embodiments of the present invention will be described in detail with reference to the accompanying drawings.

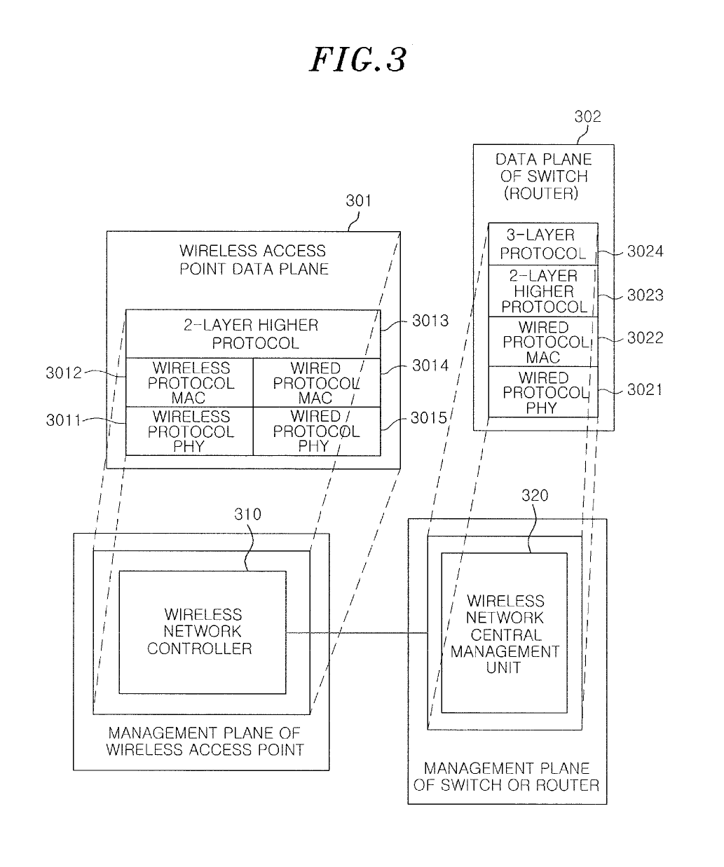

FIG. 3 is a block diagram of an apparatus for controlling a near field wireless network in accordance with an embodiment of the present invention, which may include a wireless network controller 310 implemented by hardware or software within a wireless access point, and a wireless network central management unit 320 implemented by hardware or software within a switch or a router.

As illustrated in FIG. 3, the wireless network controller 310 and the wireless network central management unit 320 in accordance with the embodiment of the present invention are implemented in a management plane of a wireless access point and a switch. Thus, since the wireless network controller 310 and the wireless network central management unit 320 are implemented in the plane separately from wireless access point data planes 301 and 302 and a control plane (not shown), they can be implemented separately from a protocol of a wireless access point or a switch.

The wireless network controller 310 and the wireless network central management unit 320 in FIG. 3 may also be implemented as partial functions in the management plane. Thus, the wireless network controller 310 may observe a wireless physical layer/media access controller layer (PHY/MAC) protocol in a wireless access point and perform a particular management procedure of a wired MAC/PHY protocol. Similarly, the wireless network central management unit 320 may perform a particular procedure of a wired MAC/PHY protocol in a switch.

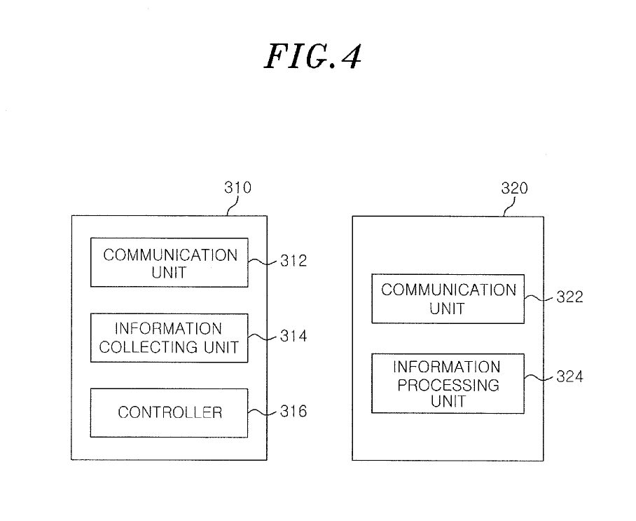

FIG. 4 is a block diagram specifically illustrating the wireless network controller 310 and the wireless network central management unit 320 in FIG. 3.

As illustrated in FIG. 4, the wireless network controller 310 may include a communication unit 312, an information collecting unit 314, and a controller 316.

Here, the communication unit 312 may serve to generate a wireless or wired MAC/PHY management frame for communication with a different communication device, e.g., a router, a wireless terminal, or the like.

The information collecting unit 314 may serve to observe a frame header of a wireless MAC/PHY frame to collect required header information in a wireless network.

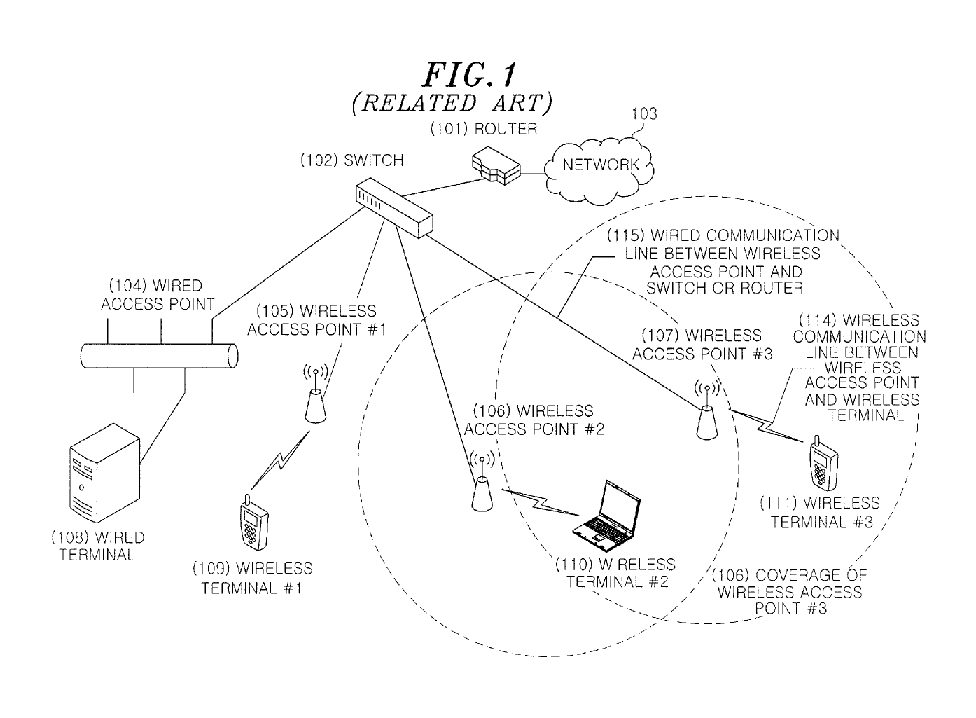

When a particular command signal is received from the wireless network central management unit 320, the controller 316 may serve to execute hardware or software of a wireless access point in response to the received command signal. In addition, the controller 316 may transmit the foregoing command signal to the wireless terminals (109, 110, and 111 in FIG. 1) through the communication unit 312, in which the command signal may be transmitted by generating a corresponding control frame.

Meanwhile, the wireless network central management unit 320 may include a communication unit 322, and an information processing unit 324.

Here, the communication unit 322 is a means or unit for performing communication with a different communication device. The communication unit 322 may serve to manage a wireless network in cooperation with a different switch connected to a different router in the network by using the 3-layer protocol layer 324 in FIG. 3. Also, the communication unit 322 may communicate with a wireless access point through a MAC/PHY frame of a wired protocol.

The information processing unit 324 may synthesize network information received from multiple wireless access points 105, 106, and 107 connected to the switch 102 to recognize and determine a situation of a network environment, determine an appropriate variable, and transmit a management command to a wireless access point required to be managed through the communication unit 322.

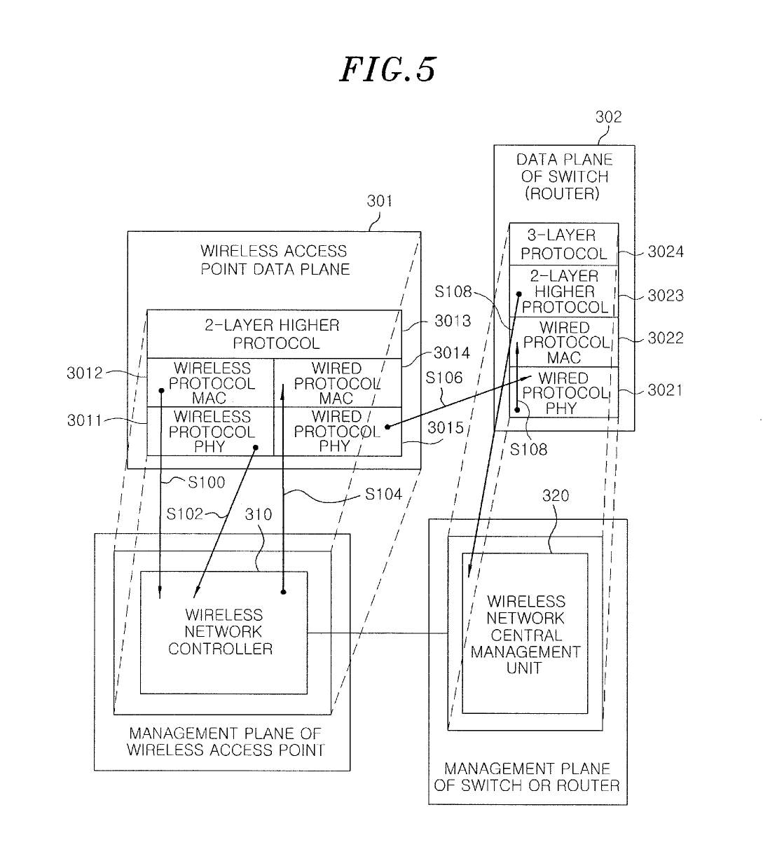

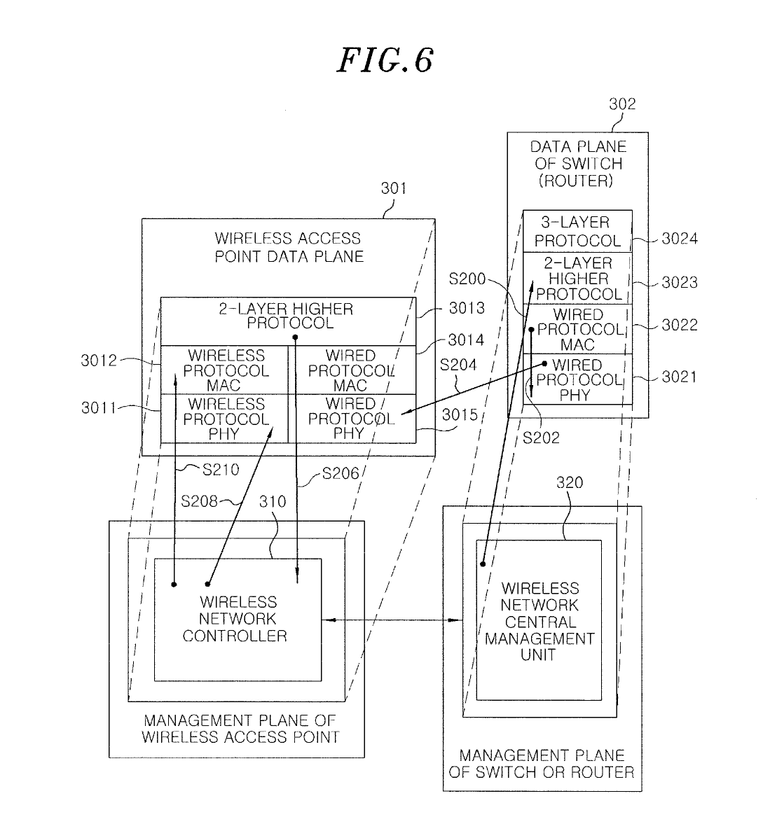

Hereinafter, a method for controlling a wireless network by the wireless network controller 310 and the wireless network central management unit 320, for example, a procedure for collecting and managing a wireless network transmission time by each wireless access point, in accordance with an embodiment of the present invention will be described in detail with reference to FIGS. 5 and 6, along with the above-mentioned configuration.

First, FIG. 5 is a view illustrating a process of collecting information in the near field wireless network in accordance with an embodiment of the present invention.

As illustrated in FIG. 5, the wireless network controller 310 may read headers of the wireless protocol MAC 3012 and the wireless protocol PHY 3011 of the wireless access point data plane 301 to collect an operation status of the corresponding wireless access network in steps S100 and S102.

The header part of the wireless protocol MAC produced in each wireless access point has network allocation vector (NAV) information. Through the NAV information, it may be possible to recognize which device is transmitted to which place in a situation in which a corresponding wireless MAC frame was transmitted and a wireless resource occupancy time may be recognized as well. In addition, through the wireless protocol PHY header, information regarding a modulation coding scheme (MCS) of a corresponding frame and signal strength may be collected.

The wireless network controller 310 may generate a wired protocol MAC frame by using the information collected through the header of the wireless protocol MAC 3012 and the header of the wireless protocol PHY 3011 in step S104, and transmit a wireless protocol PHY 3015 frame and a wired protocol PHY 3021 frame to the switch including the wireless network central management unit 320 as a destination of the information in step S106.

When the received wired protocol PHY frame reaches the 2-layer higher protocol in step S108, the switch may obtain the foregoing information, e.g., the NAV information, the MCS information, the signal strength information, and the like through the wireless network central management unit 320 in step S110.

Through such information, the information processing unit 324 of the wireless network central management unit 320 may process the information received from multiple wireless access points and transmit a management command corresponding to the corresponding wireless access points.

FIG. 6 is a view illustrating a procedure for processing a command by the wireless network central management unit 320 in the near field wireless network in accordance with an embodiment of the present invention.

The embodiment of FIG. 6 may be performed in reverse order of the collecting process of FIG. 5.

First, after completing the evaluation of an environment of the wireless network, when the wireless network central management unit 320 wants to manage a particular wireless access point, it may generate a wired protocol MAC frame and a wired protocol SHY frame by using a 2-layer upper protocol 3023 in steps S200 and S202.

When the generated wired protocol MAC frame and wired protocol PHY frame are transmitted to the wireless access point data plane 301 in step S204, the wireless network controller 310 of the wireless access point may receive a command from the wireless network central management unit 320 through step S206.

Finally, the wireless network may be controlled by controlling a MAC/PHY process of the wireless protocols through step S208 or S210 based on the content of the command.

Meanwhile, an interference cancellation technique for a wireless terminal in a region in which wireless signals of the wireless access point 106 and the wireless access point 107 in FIG. 1 are superposed in accordance with an embodiment of the present invention will be described by way of illustration.

First, the wireless network controller 310 of the wireless access point 106 analyzes a frame received from the wireless terminal 110, and when it is determined that interference has occurred at a particular time of the wireless access point 107, the wireless network controller 310 collects MAC/PHY header information of the received frame and reports the same to the wireless network central management unit 320 in the same manner as that of FIG. 5.

Based on the reported information, the wireless network central management unit 320 instructs the wireless access point 107 to collect information through the procedure as shown in FIG. 6, and the wireless access point 107 reports the results to the wireless network central management unit 320 through the procedure of FIG. 5.

The wireless network central management unit 320 creates a table based on the NAV information, signal strength, MCS, and the like of the respective wireless access points included in the collected information, and displays a time during which transmission durations are not overlapped and a time during which transmission durations are overlapped.

The wireless network central management unit 320 may transmit the calculated overlap time information to the wireless access point 106 and the wireless access point 107 and instruct them to perform an interference cancellation technique through the procedure as shown in FIG. 6 at the corresponding time, so that an interference effect between adjacent wireless networks can be removed during the overlap time.

In this manner, in the present invention, the scheme of controlling a wireless network through the wireless network controller and the central management unit within the switch and the wireless access point is disclosed.

As described above, in accordance with the embodiments of the present invention, a scheme of managing a wireless network using a wired line within a switch is proposed, whereby the complexity of wireless protocol management due to direct communication between wireless access points can be removed and simple, fast, and intelligent management of a wireless network can be implemented without an additional revision of a 2-layer protocol through a switch to which wireless access points are connected.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for controlling a near field wireless network, comprising:
a wireless network controller included in a management plane of a wireless access point and configured to observe wireless physical layer/media access controller layer (PHY/MAC) protocols and perform a management procedure on wired MAC/PHY protocols within the wireless access point, and
a wireless network central management unit included in a management plane of a switch and configured to perform a management procedure on the wired MAC/PHY protocols within the switch.

2. The apparatus of claim 1, wherein the wireless network controller and the wireless network central management unit are implemented in a plane separately from a data plane and a control plane.

3. The apparatus of claim 1, wherein the switch comprises at least one switch equipment.

4. The apparatus of claim 1, wherein the wireless network controller comprises:
a communication unit configured to generate a wireless MAC/PHY management frame or a wired MAC/PHY management frame for communication with a second communication device;
an information collecting unit configured to collect header information from a frame header of the wireless MAC/PHY management frame; and
a controller configured to execute hardware or software of the wireless accession point in response to a command signal received from the wireless network central management unit.

5. The apparatus of claim 4, wherein the controller is configured to transmit the command signal to a wireless terminal through the communication unit.

6. The apparatus of claim 5, wherein the command signal is transmitted to the wireless terminal through the use of a control frame.

7. The apparatus of claim 1, wherein the wireless network central management unit comprises:
a communication unit configured to perform a communication with a second communication device so that it is connected to a second switch connected to a second router in a network by using a 3-layer protocol included in a data plane of the switch through a wireless network; and
an information processing unit configured to analyze network information received from at least one wireless access point connected to the switch to recognize and determine a situation of a network environment.

8. The apparatus of claim 7, wherein the communication unit is configured to communicate with the wireless access point through the use of a MAC/PHY frame of the wired protocol.

9. The apparatus of claim 7, wherein the information processing unit is configured to determine a random variable and transmit a management command to a wireless access point required to be managed through the communication unit.

10. A method for controlling a near field wireless network by a wireless network controller, comprising:
reading a header of a wireless protocol media access control (MAC) and a header of a wireless protocol physical layer (PHY) of a data plane of a wireless access point to collect an operation status of a corresponding wireless access network;
generating a wired protocol MAC frame by using the information collected through the header of the wireless protocol MAC and the header of the wireless protocol PHY; and
transmitting a wired protocol PHY frame and a wired protocol MAC frame to a switch including a wireless network central management unit as a destination of the information.

11. The method of claim 10, wherein wireless network central management unit is configured to process the information collected through the headers of the wireless protocol MAC and the wireless protocol PHY and transmit a management command to the wireless access point.

12. The method of claim 10, wherein the header of the wireless protocol MAC comprises network allocation vector (NAV) information.

13. The method of claim 12, wherein the NAV information comprises information used to recognize a target device to which a wireless MAC frame is transmitted.

14. The method of claim 13, wherein the NAV information comprises information regarding a wireless resource occupancy time.

15. The method of claim 10, wherein the header of the wireless protocol PHY comprises information regarding a modulation coding scheme (MCS) of a corresponding frame and signal strength.

16. A method for controlling a near field wireless network by a wireless network central management unit, comprising:
generating a wired protocol media access controller (MAC) frame and a wired protocol physical layer (PHY) frame by using a 2-layer higher protocol for a wireless access point in a wireless network environment;
transmitting the generated wired protocol MAC frame and wired protocol PHY frame to a data plane of the wireless access point; and
transmitting a wireless network control command to a wireless network controller of the wireless access point.

17. The method of claim 16, wherein the wireless network controller is configured to control a MAC/PHY process of a wireless protocol in response to the wireless network control command to control the near field wireless network.
